(19) United States
(12) Patent Application Publication
(10) Pub. No.: US 2009/0303731 A1
(43) Pub. Date: Dec. 10, 2009

(54) Light-Transmittable Cover For a Light-Emitting Diode Bulb

(76) Inventor: Yu-Chen Chang, Taichung County (TW)

Correspondence Address: Dr. BANGER SHIA, 102 Lindencrest Ct., Sugar Land, TX, 77479-5201, US

(21) Appl. No.: 12/135,205

(22) Filed: Jun. 8, 2008

(51) Int. Cl. F21V 7/00

(52) U.S. Cl. 362/341

(57) ABSTRACT

A light-transmittable cover for a light-emitting diode bulb is provided on a bulb adaptor having at least one light-emitting diode and covers the light-emitting diode. The light-transmittable cover comprises a reflective layer on an outside surface of a top thereof to reflect the light emitted from the light-emitting diode to an area where the light-emitting diode cannot reach.

### BACKGROUND OF THE INVENTION

1. Field of the Invention

The present invention relates to a lamp cover, and more particularly to a light-transmittable cover for a light-emitting diode bulb.

2. Description of the Prior Art

As compared with tungsten lamps, the light-emitting diodes have the advantages of high brightness, low temperature. It is obvious that the light-emitting diodes are better than the tungsten lamps in practicality. However, the tungsten lamps have been widely used, so if they were completely replaced by the light-emitting diodes, it would cost a lot of money.

Hence, a technology (such as high power light-emitting diode lamp disclosed in Taiwan Pat. No. 095103608) which enables the LED to be compatible with the conventional bulb adaptor has been developed. Therefore, the light-emitting diodes can completely replace the conventional tungsten lamps with a lower cost.

However, the irradiation range (the illumination area) of the existing light-emitting diodes is limited to the front side of the light-emitting diode. Because the lighting angle is too small, the emitting light cannot irradiate the rear side (such as the position of the bulb adaptor or the lamp cover) of the light-emitting diode.

The present invention has arisen to mitigate and/or obviate the afore-described disadvantages.

### SUMMARY OF THE INVENTION

The primary objective of the present invention is to provide a light-transmittable cover for a light-emitting diode bulb, which utilizes a reflective layer to reflect the light emitted from the light-emitting diode to an area where a common light-emitting diode cannot reach, such as the bulb adaptor and its surrounding area.

In order to achieve the above objective, the light-transmittable cover is provided on a bulb adaptor having at least one light-emitting diode and covers the light-emitting diode. The light-transmittable cover comprises at least one reflective layer on an outside surface of the top thereof, and the reflective layer has a reflective surface located within an irradiation range of the light-emitting diode and reflects the light emitted from the light-emitting diode in a predetermined direction.

### BRIEF DESCRIPTION OF THE DRAWINGS

FIG. 1 is a perspective view showing that a light-transmittable cover for a light-emitting diode bulb is provided on a bulb adaptor;

FIG. 2 is cross-sectional view showing that the bulb of FIG. 1 is provided on a table lamp;

FIG. 3 is a perspective view showing that the reflective layer of the present invention is ring-shaped in cross-section;

FIG. 4 is a cross-sectional view showing that the bulb of FIG. 3 is provided on a ceiling lamp;

FIG. 5 is a perspective view showing that the bulb adaptor in accordance with the present invention has a plurality of light-emitting diodes;

FIG. 6 is a cross-sectional view showing that the bulb of FIG. 5 is provided on a ceiling lamp;

FIG. 7 is a perspective view showing that the reflective layer in accordance with the present invention is ring-shaped in cross section and provided on the bulb adaptor having a plurality of light-emitting diodes; and

FIG. 8 is a cross-sectional view showing that the bulb of FIG. 7 is provided on the ceiling lamp.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

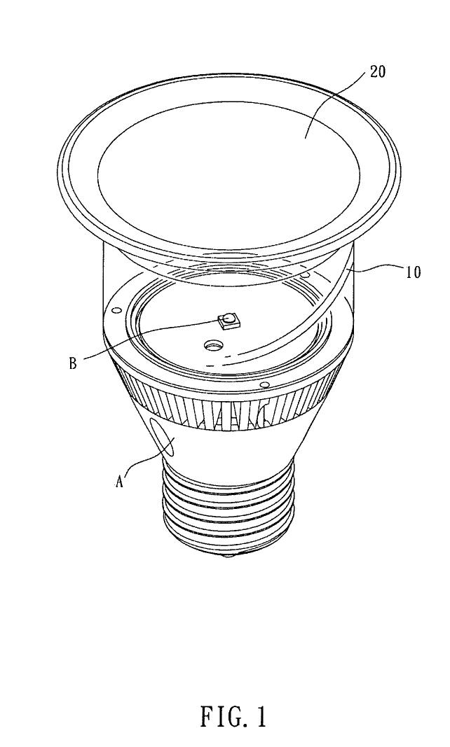

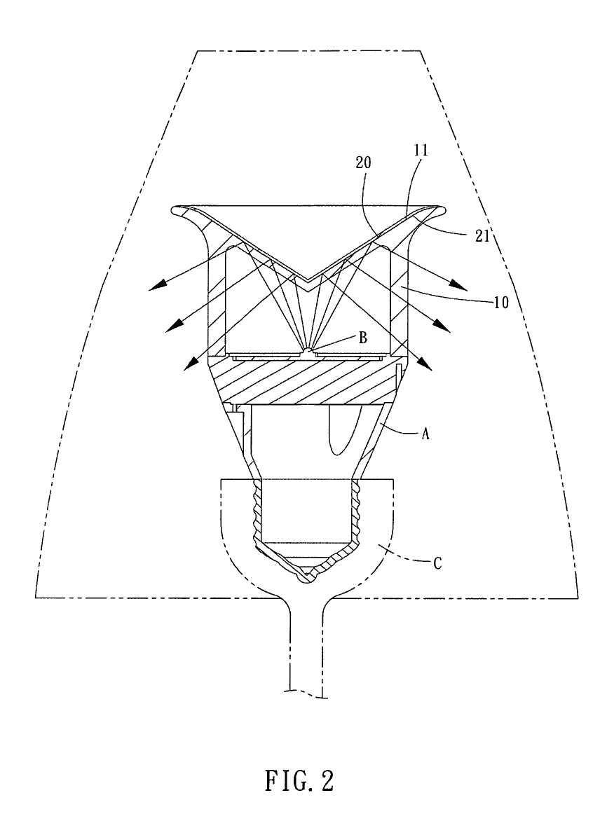

Referring to FIG. 1, a light-transmittable cover for a light-emitting diode bulb in accordance with a preferred embodiment of the present invention is provided on a bulb adaptor A. The bulb adaptor A is provided with a light-emitting diode B, and the light-transmittable cover 10 covers the light-emitting diode B. As shown in FIG. 2, the bulb is provided on a table lamp C.

The light-transmittable cover 10 is provided with a molding surface 11 on an outside surface of a top thereof. The center of the molding surface 11 protrudes toward the bulb adaptor A, and the molding surface 11 includes a reflective layer 20. The reflective layer 20 can be a film-shaped structure formed by painting or plating, or it can be a sheet-shaped structure which is directly provided on the molding surface 11. The reflective layer 20 includes a reflective surface 21 adhered to the molding surface 11. The reflective surface 21 is located within the irradiation range of the light-emitting diode B in such a manner that the light emitted from the light-emitting diode B is projected on the reflective surface 21 of the reflective layer 20. By such arrangements, the light emitted from the light-emitting diode B can be reflected by the reflective surface 21 of the reflective layer 20 to an area where the light-emitting diode B cannot reach, such as the bulb adaptor A and its surrounding area.

Moreover, the light-transmittable cover 10 is adhered or screwed to the bulb adaptor A.

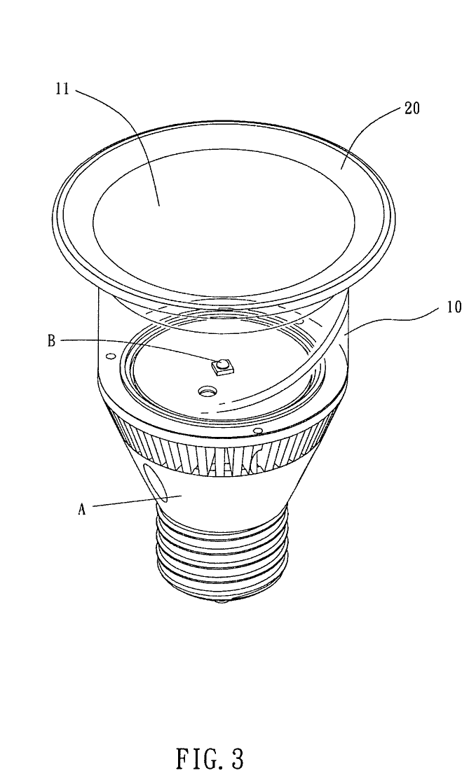

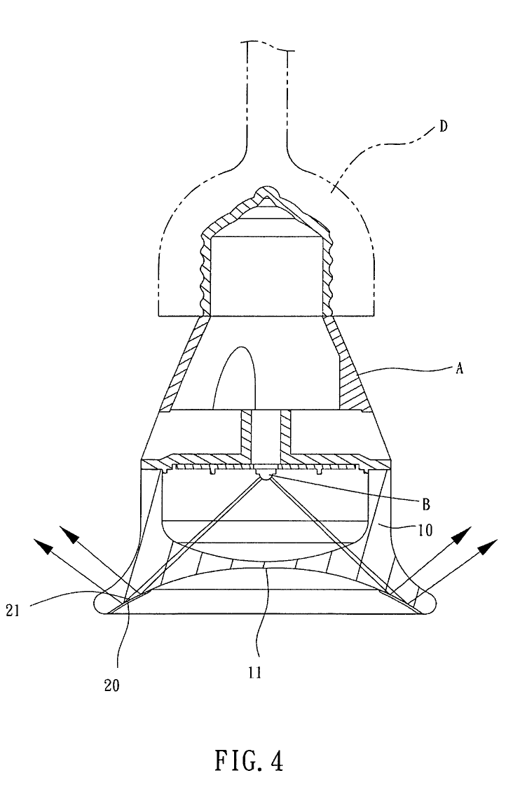

In addition, the light-transmittable cover 10 can also be as shown in FIG. 3, and the reflective layer 20 is ring-shaped in cross section and located at the periphery of the molding surface 11. As shown in FIG. 4, the bulb is provided on a ceiling lamp D. The center of the molding surface 11 can transmit light, and the reflective surface 21 of the reflective layer 20 can reflect the light emitted from the light-emitting diode B.

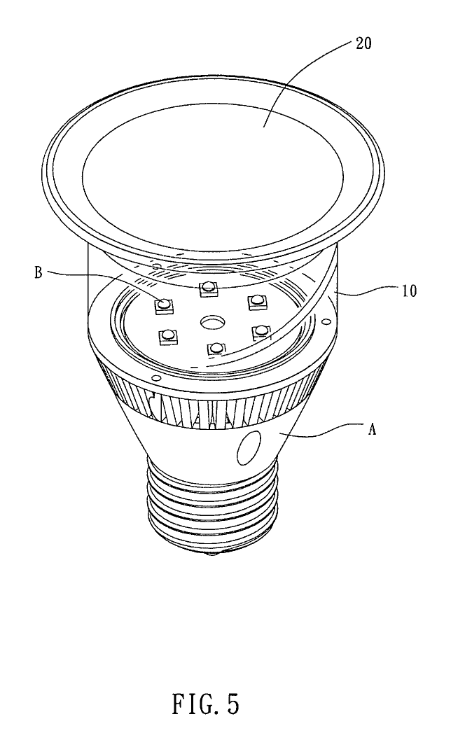

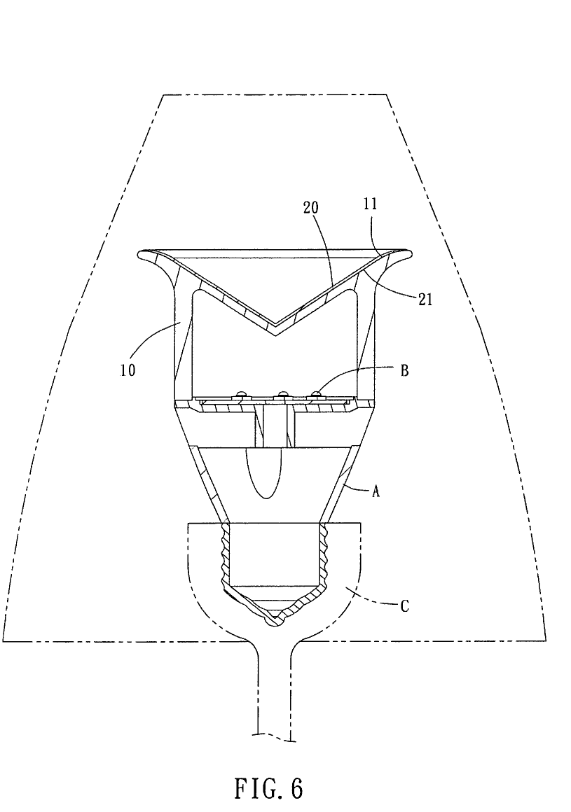

As shown in FIG. 5, such a light-transmittable cover 10 is applied to a bulb adaptor A having a plurality of light-emitting diodes B. The center of the molding surface 11 protrudes toward the bulb adaptor A, and the reflective layer 20 is round in cross section. As shown in FIG. 6, the bulb of FIG. 5 is provided on the table lamp C.

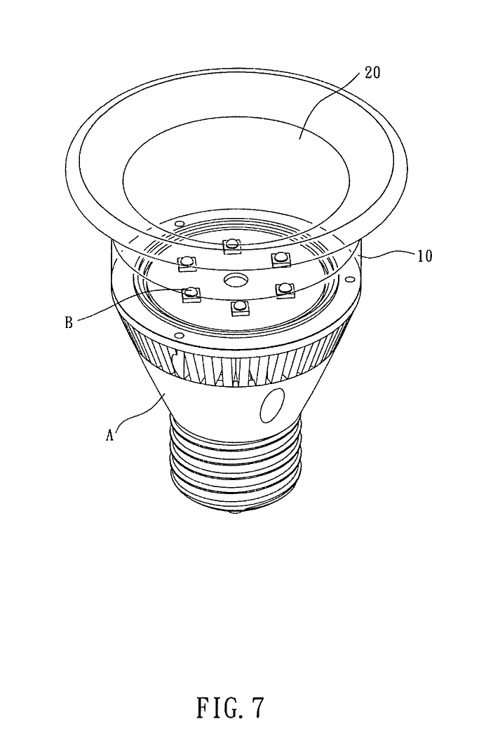

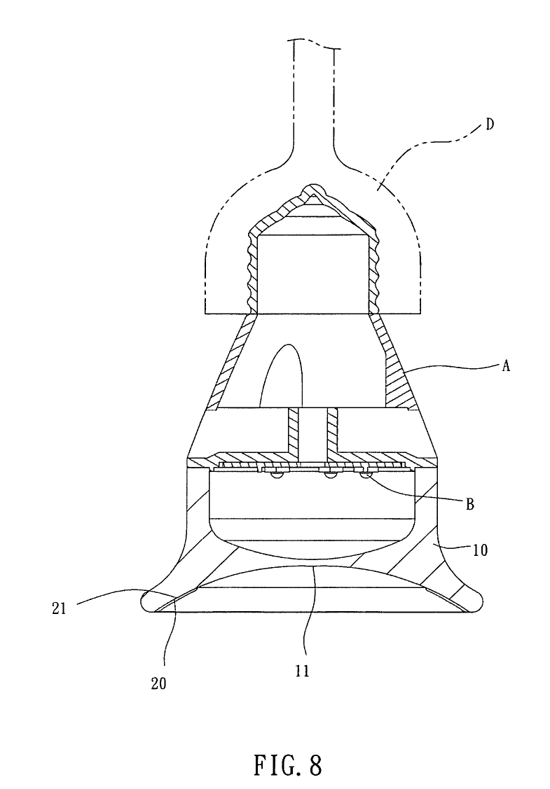

In addition, as shown in FIG. 7, the reflective layer 20 is ring-shaped in cross section and located at the periphery of the molding surface 11, and the bulb of FIG. 7 is provided on the ceiling lamp D as shown in FIG. 8. The reflective surface 21 of the reflective layer 20 can be also used to reflect the light emitted form the light-emitting diodes to the bulb adaptor A and its surrounding area, offering the function of reflecting the light to an area where the light-emitting diode B cannot reach.

While we have shown and described various embodiments in accordance with the present invention, it is clear to those skilled in the art that further embodiments may be made without departing from the scope of the present invention.

What is claimed is:

1. A light-transmittable cover for a light-emitting diode bulb being provided on a bulb adaptor having at least one light-emitting diode and covering the light-emitting diode, wherein:
the light-transmittable cover comprises a reflective layer on an outside surface of a top thereof, the reflective layer has a reflective surface located within an irradiation range of the light-emitting diode, and light emitted from the light-emitting diode is projected on the reflective surface and then will be reflected by the reflective surface.

2. The light-transmittable cover for a light-emitting diode bulb as claimed in claim 1, wherein the light-transmittable cover is provided with a molding surface on the outside surface of the top thereof, the reflective layer is located on the molding surface, the reflective surface of the reflective layer is adhered to the molding surface, a center of the molding surface protrudes toward the bulb adaptor.

3. The light-transmittable cover for a light-emitting diode bulb as claimed in claim 2, wherein the reflective layer is round in cross section.

4. The light-transmittable cover for a light-emitting diode bulb as claimed in claim 2, wherein the reflective layer is ring-shaped in cross section and located at a periphery of the molding surface.

5. The light-transmittable cover for a light-emitting diode bulb as claimed in claim 1, wherein the bulb adaptor includes a plurality of light-emitting diodes.

6. The light-transmittable cover for a light-emitting diode bulb as claimed in claim 5, wherein the light-transmittable cover is provided with a molding surface on the outside surface of the top thereof, the reflective layer is located on the molding surface, and the reflective surface of the reflective layer is adhered to the molding surface, a center of the molding surface protrudes toward the bulb adaptor.

7. The light-transmittable cover for a light-emitting diode bulb as claimed in claim 6, wherein the reflective layer is round in cross section.

8. The light-transmittable cover for a light-emitting diode bulb as claimed in claim 6, wherein the reflective layer is ring-shaped in cross section and located at a periphery of the molding surface.

9. The light-transmittable cover for a light-emitting diode bulb as claimed in claim 1, wherein the reflective layer is formed on the light-transmittable cover by painting.

10. The light-transmittable cover for a light-emitting diode bulb as claimed in claim 1, wherein the reflective layer is formed on the light-transmittable cover by plating.

11. The light-transmittable cover for a light-emitting diode bulb as claimed in claim 1, wherein the reflective layer is a sheet-shaped structure, which is directly provided on the light-transmittable cover.

12. The light-transmittable cover for a light-emitting diode bulb as claimed in claim 1, the light-transmittable cover is adhered to the bulb adaptor.

13. The light-transmittable cover for a light-emitting diode bulb as claimed in claim 1, the light-transmittable cover is screwed to the bulb adaptor.
